(19) United States
(12) Patent Application Publication
(10) Pub. No.: US 2013/0163220 A1
(43) Pub. Date: Jun. 27, 2013

(54) ELECTRONIC DEVICE WITH CABLE PROTECTING STRUCTURE

(71) Applicants: XIU-QUAN HU, Shenzhen City (CN); XIU-ZHONG YIN, Shenzhen City (CN)

(72) Inventors: XIU-QUAN HU, Shenzhen City (CN); XIU-ZHONG YIN, Shenzhen City (CN)

(21) Appl. No.: 13/632,391

(22) Filed: Oct. 1, 2012

(30) Foreign Application Priority Data
Dec. 24, 2011 (CN) 201110438373.3

(51) Int. Cl. H02B 1/20

(52) U.S. Cl. 361/826

(57) ABSTRACT

An electronic device includes a chassis and a protecting member. The chassis includes a side plate, a bottom plate substantially perpendicular to the side plate, a plurality of first components secured to the bottom plate, and a plurality of connectors located between the side plate and the plurality of first components. The plurality of connectors is adapted for connecting to a plurality of cables. The protecting member is secured to the side plate and includes a protecting plate. The protecting plate is substantially parallel to the bottom plate. The protecting plate and the bottom plate are adapted to receive the plurality of cables therebetween.

### BACKGROUND

1. Technical Field

The present disclosure relates to electronic devices, and particularly to an electronic device with a cable protecting structure.

2. Description of Related Art

A number of servers are mounted in a rack. In order to save space, the servers are stacked one by one. However, cables, particularly thick cables, used in each server are easy frayed or scratched by chassis of other servers when each server is secured to or removed from the rack. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of an electronic device.

FIG. 2 is an isometric view of a protecting member of the electronic device of FIG. 1.

FIG. 3 is an assembled, isometric view of the electronic device of FIG. 1.

FIG. 4 is similar to FIG. 3, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

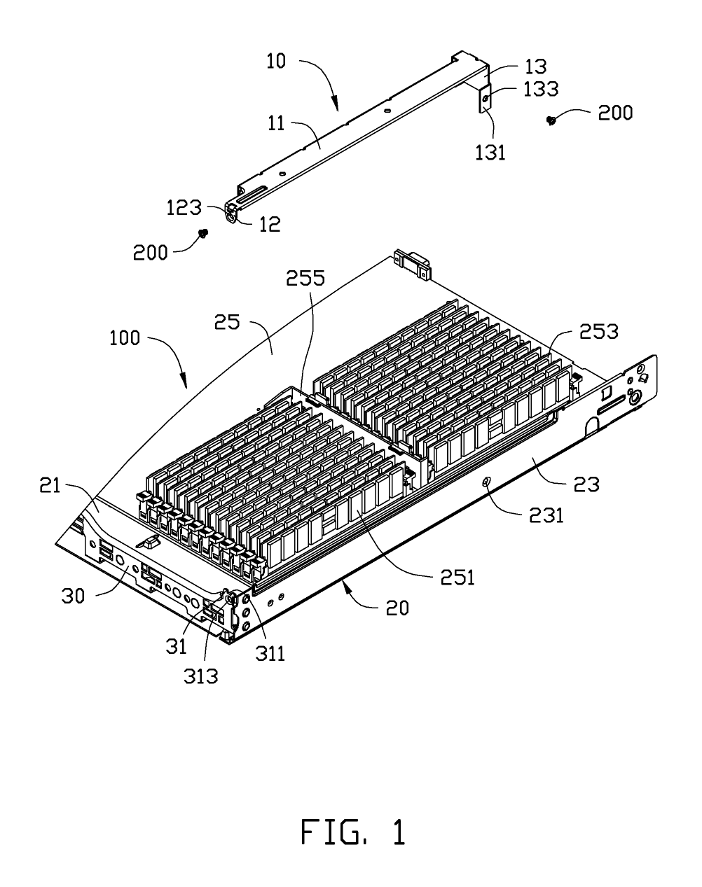

Referring to FIG. 1, an electronic device in accordance with an embodiment is shown. The electronic device comprises a host 100 and a protecting member 10.

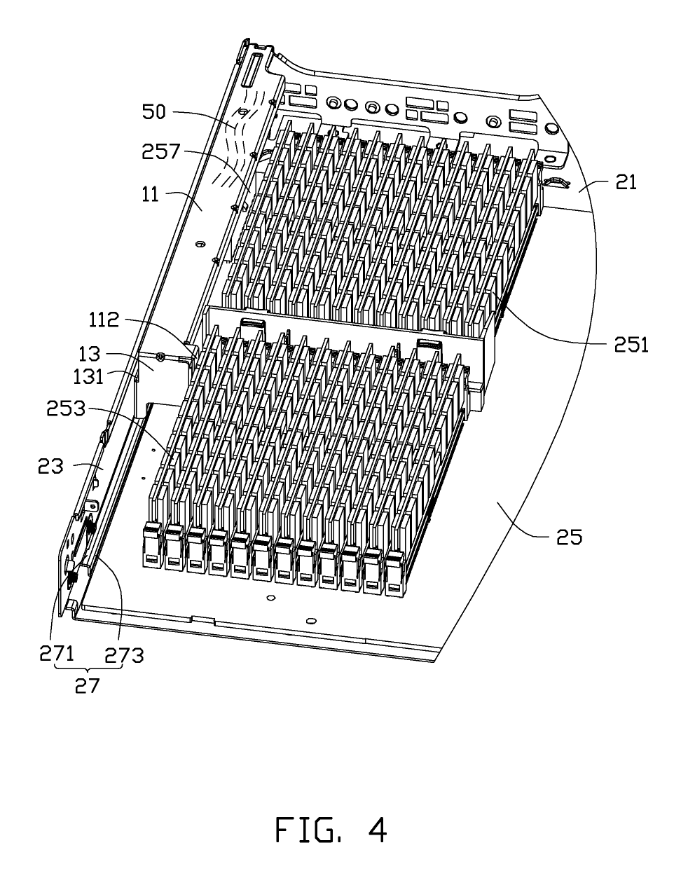

The host 100 comprises a chassis 20. The chassis 20 comprises a bottom plate 21 and a side plate 23, perpendicularly connected to the bottom plate 21. A circuit board 25 and a support member 30 are secured to the bottom plate 21. Referring to FIG. 4, a flange 27 connects the bottom plate 21 to the side plate 23. The flange 27 comprises a support board 271 and a connecting board 273. In one embodiment, the connecting board 273 is substantially perpendicular to the bottom plate 21, and the support board 271 is substantially perpendicular to the side plate 23 and the connecting board 273.

A plurality of first components 251 and a plurality of second components 253 are secured to the circuit board 25. The plurality of first components 251 are substantially parallel to each other and to the side plate 23. The plurality of second components 253 are substantially parallel to each other and to the side plate 23. A blocking plate 255 is secured to the circuit board 25. The blocking plate 255 is located between the plurality of first components 251 and the plurality of second components 253. A plurality of connectors 257 (shown as in FIG. 4) is located between the side plate 23 and one of the plurality of first components 251 adjacent to the side plate 23. Each of the plurality of connectors 257 connects to a cable of the plurality of cables 50 (shown as dotted lines 50 in FIG. 4). The plurality of cables 50 extends to the support member 30. The side plate 23 defines a locking hole 231. In one embodiment, each of the plurality of first components 251 and the plurality of second components 253 are memories.

The support member 30 is substantially perpendicular to the side plate 23 and to the bottom plate 21. An installation piece 31 extends from a top edge of the support member 30. The installation piece 31 is adjacent to the side plate 23 and defines a cutout 311 and an installation hole 313.

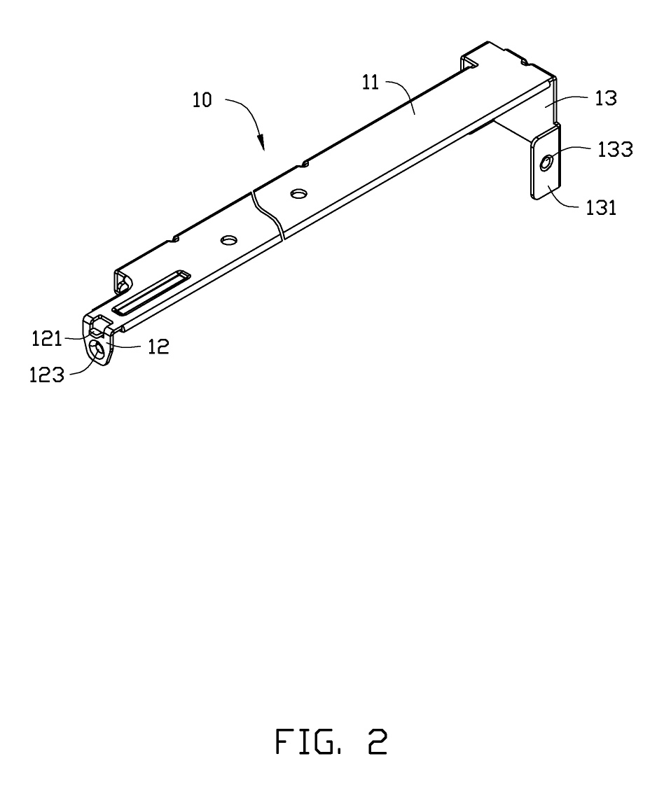

Referring to FIG. 2, the protecting member 10 comprises a protecting plate 11, a positioning piece 12, and a blocking piece 13. The positioning piece 12 and the blocking piece 13 extend from opposite edges of the protecting plate 11. In one embodiment, the positioning piece 12 and the blocking piece 13 are substantially perpendicular to the protecting plate 11. A positioning tab 121 extends outwards from the positioning piece 12. The positioning piece 12 defines a through hole 123. In one embodiment, the positioning tab 121 is substantially perpendicular to the positioning piece 12. A resisting piece 112 (shown as in FIG. 4) extends from en edge of the protecting plate 11. The resisting piece 112 is substantially perpendicular to the protecting plate 11 and the blocking piece 13. A locking piece 131 extends from en edge of the blocking piece 13. The locking piece 131 is substantially parallel to the resisting piece 112. A width of the blocking piece 13 is substantially equal to a distance between the resisting piece 112 and the locking piece 131.

The locking piece 131 defines a mounting hole 133.

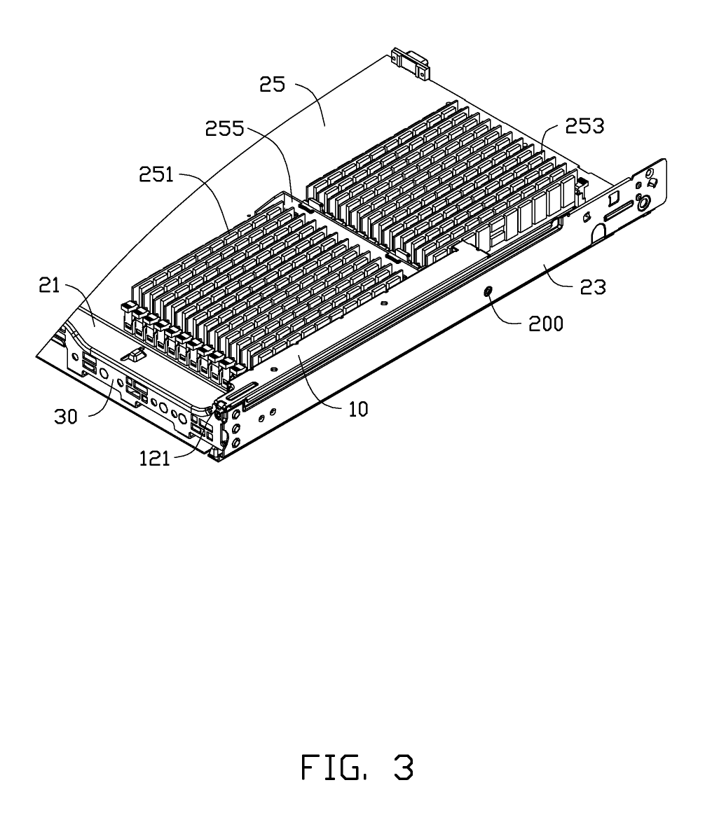

FIG. 3 and FIG. 4 show that, in assembly, the protecting member 10 is placed between the side plate 23 and the one of the plurality of first components 251. The protecting member 10 is flexed to insert the positioning tab 121 in the cutout 311. The protecting member 10 is moved towards the bottom plate 21 until the blocking piece 13 abuts the support board 271. In this position, the positioning piece 12 abuts the installation piece 31, and the locking piece 131 abuts the side plate 23. The through hole 123 is aligned with the installation hole 313, and the mounting hole 133 is aligned with the locking hole 231. One of two locking members 200, such as a screw, is screwed into the installation hole 313 and the through hole 123. The other of the two locking members 200 is screwed into the locking hole 231 and the mounting hole 133. Thus, the protecting member 10 is secured to the side plate 23 and to the support member 30. In one embodiment, the protecting plate 11 and the blocking piece 13 are substantially perpendicular to the side plate 23. The resisting piece 112 abuts one of the plurality of second components 253 adjacent to the side plate 23. All of the cables 50 are received between the protecting member 10 and the bottom plate 21 and between the side plate 23 and the one of the plurality of first components 251.

In use, the protecting member 10 keeps the cables 50 captive below a top edge of the side plate 23. When other chassis is stacked above the chassis 20, the protecting member 10 functions to protect the cables 50 from contact with the other chassis. Thus, the cables 50 are prevented from being scratched by other chassis when the chassis 20 is moved relative to the other chassis.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. An electronic device, comprising:
a chassis comprising a side plate, a bottom plate substantially perpendicular to the side plate, a plurality of first components secured to the bottom plate, and a plurality of connectors located between the side plate and the plurality of first components; and the plurality of connectors configured to connect a plurality of cables; and
a protecting member secured to the side plate and comprising a protecting plate;
wherein the protecting plate is substantially parallel to the bottom plate, and the protecting plate and the bottom plate are configured to receiving the plurality of cables therebetween.

2. The electronic device of claim 1, wherein the chassis further comprises a blocking plate and a plurality of second components secured to the bottom plate; the blocking plate is located between the plurality of first components and the plurality of second components; and a height of the blocking plate is substantially equal to a height of one of plurality of first components or one of the plurality of second components.

3. The electronic device of claim 2, wherein the protecting member further comprises a positioning piece and a blocking piece, and the blocking piece is located between the side plate and the plurality of second components; and the chassis further comprises a support member secured to the bottom plate, and the positioning piece is secured to the support member.

4. The electronic device of claim 3, wherein the positioning piece and the blocking piece extend from two opposite edges of the protecting plate; the positioning piece and the blocking piece are substantially perpendicular to the protecting plate; and the support member is substantially perpendicular to the bottom plate and the side plate.

5. The electronic device of claim 3, wherein the protecting member further comprises a positioning tab extending from the positioning piece; an installation piece extends from a top edge of the support member; the installation piece defines a cutout, and the positioning tab is engaged in the cutout.

6. The electronic device of claim 5, wherein the installation piece further defines an installation hole; the positioning piece defines a through hole; the installation hole is aligned with the through hole; and the installation hole and the through hole are adapted to secure the installation piece to the positioning piece.

7. The electronic device of claim 3, wherein the protecting member further comprises a locking piece extending from the protecting plate, the locking piece is substantially parallel to the blocking piece, and the locking piece abuts against and is secured to the side plate.

8. The electronic device of claim 7, wherein the protecting member further comprises a resisting piece substantially parallel to the locking piece, and the resisting piece abuts one of the plurality of second components adjacent to the side plate.

9. The electronic device of claim 8, wherein a width of the blocking piece is substantially equal to a distance between the resisting piece and the locking piece.

10. The electronic device of claim 8, wherein the locking piece defines a mounting hole, the side plate defines a locking hole, and the mounting hole is aligned with the locking hole.

11. An electronic device, comprising:
a chassis comprising a side plate, a bottom plate substantially perpendicular to the side plate, a plurality of first components and a plurality of second components secured to the bottom plate, and a plurality of connectors located between the side plate and the plurality of first components; and the plurality of connectors being configured to connect a plurality of cables;
a protecting member secured to the side plate and comprising a protecting plate; and
a blocking plate secured to the bottom plate and located between the plurality of first components and the plurality of second components;
wherein the protecting plate is substantially parallel to the bottom plate, and the protecting plate and the bottom plate are configured to receive the plurality of cables therebetween.

12. The electronic device of claim 11, wherein a height of the blocking plate is substantially equal to a height of each of plurality of first components and the plurality of second components.

13. The electronic device of claim 12, wherein the protecting member further comprises a positioning piece and a blocking piece, and the blocking piece is located between the side plate and the plurality of second components; and the chassis further comprises a support member secured to the bottom plate, and the positioning piece is secured to the support member.

14. The electronic device of claim 13, wherein the positioning piece and the blocking piece extend from two opposite edges of the protecting plate; the positioning piece and the blocking piece are substantially perpendicular to the protecting plate; and the support member is substantially perpendicular to the bottom plate and the side plate.

15. The electronic device of claim 13, wherein the protecting member further comprises a positioning tab extending from the positioning piece; an installation piece extends from a top edge of the support member; the installation piece defines a cutout, and the positioning tab is engaged in the cutout.

16. The electronic device of claim 15, wherein the installation piece further defines an installation hole; the positioning piece defines a through hole; the installation hole is aligned with the through hole; and the installation hole and the through hole are adapted to secure the installation piece to the positioning piece.

17. The electronic device of claim 13, wherein the protecting member further comprises a locking piece extending from the protecting plate, the locking piece is substantially parallel to the blocking piece, and the locking piece abuts against and is secured to the side plate.

18. The electronic device of claim 17, wherein the protecting member further comprises a resisting piece substantially parallel to the locking piece, and the resisting piece abuts one of the plurality of second components adjacent to the side plate.

19. The electronic device of claim 18, wherein a width of the blocking piece is substantially equal to a distance between the resisting piece and the locking piece.

20. The electronic device of claim 18, wherein the locking piece defines a mounting hole, the side plate defines a locking hole, and the mounting hole is aligned with the locking hole.
